(19) United States
(12) Patent Application Publication
(10) Pub. No.: US 2026/0349368 A1
(43) Pub. Date: Nov. 5, 2026

(54) IMAGE FORMING APPARATUS

(71) Applicant: CANON KABUSHIKI KAISHA, Tokyo (JP)

(72) Inventors: KEN OI, Tokyo (JP); DAIGO YAMAUCHI, Kanagawa (JP)

(21) Appl. No.: 19/549,643

(22) Filed: Feb. 25, 2026

(30) Foreign Application Priority Data
Mar. 3, 2025 (JP) 2025-033159

(51) Int. Cl. G03G 15/08; G03G 15/01

(52) U.S. Cl. CPC G03G 15/086; G03G 15/0173

(57) ABSTRACT

An image forming apparatus includes a magnetic sensor arranged outside a rotary and configured to detect a magnetic field formed by a permanent magnet held inside an accommodation unit that accommodate toner, to output a signal. The image forming apparatus further includes a control unit configured to determine a toner amount inside the accommodation unit based on a signal (first signal) that is output by the magnetic sensor upon detecting an S pole of the permanent magnet, and a signal (second signal) that is output by the magnetic sensor upon detecting an N pole of the permanent magnet.

### BACKGROUND

### Field of the Technology

The present disclosure relates to a technique for detecting a remaining toner amount in an image forming apparatus.

### Description of the Related Art

An image forming apparatus described in Japanese Patent Laid-Open No. 2022-147188 includes a movable magnetic body inside an accommodation unit that accommodates a developer (toner), and detects the amount of developer inside the accommodation unit by detecting magnetism generated by the magnetic body.

### SUMMARY

The present disclosure provides a novel image forming apparatus that determines a remaining amount of toner inside a toner accommodation unit.

According to one aspect of the present disclosure, there is provided an image forming apparatus, comprising: a development unit including (I) an accommodation unit configured to accommodate toner and which includes a permanent magnet therein, the permanent magnet being changeable in position relative to the accommodation unit in accordance with a toner amount inside the accommodation unit, and (II) a development roller that develops an electrostatic latent image formed on a photosensitive member with use of the toner accommodated in the accommodation unit; a rotary that supports the development unit and which is rotatable; a magnetic sensor arranged outside the rotary to detect a magnetic field formed by the permanent magnet and to output a signal based on the detection; and a control unit that determines the toner amount inside the accommodation unit based on the output signal, wherein the magnetic sensor is a bipolar detection sensor that detects both an S pole and an N pole of the permanent magnet, and when the output signal output by the magnetic sensor upon detecting the S pole of the permanent magnet is a first signal, and when the output signal output by the magnetic sensor upon detecting the N pole of the permanent magnet is a second signal, the control unit determines the toner amount in the accommodation unit based on the first signal and the second signal.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional diagram showing an exemplary hardware configuration of an image forming apparatus.

FIG. 2 is a cross-sectional diagram showing an exemplary configuration related to a rotary, a plurality of development devices, and a magnetic sensor.

FIG. 3A and FIG. 3B are cross-sectional diagrams showing an exemplary configuration for determining an amount of toner inside a development device.

FIG. 4 is a block diagram showing an exemplary control configuration of the image forming apparatus.

FIG. 5 shows an example of electrical connection between a CPU and a magnetic sensor.

FIG. 6A shows an example of a change in the magnetic flux density of the magnetic flux penetrating through the magnetic sensor.

FIG. 6B shows an example of a change in an output signal of the magnetic sensor.

FIG. 7 is a flowchart showing an example of a procedure of determination control for a toner amount.

FIG. 8A and FIG. 8B show examples of a relationship between a toner amount inside a development device and a magnetic flux density ratio R_{S/N}.

FIG. 9 is a flowchart showing an example of a procedure of determination control for a toner amount (a second embodiment).

FIG. 10A shows an example of a relationship between a toner amount inside a development device and an output signal of the magnetic sensor.

FIG. 10B shows an example of a relationship between a toner amount inside a development device and an integral value ratio Rᵢₙₜ.

FIG. 11A shows an example of a relationship between a toner amount inside a development device and a magnetic flux density ratio R_{S/N}.

FIG. 11B shows an example of a relationship between a toner amount inside a development device and an integral value ratio Rᵢₙₜ.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

The following embodiment will be described in relation to a laser printer that performs image formation of an electrophotographic method, as an example of an image forming apparatus of the present disclosure. The image forming apparatus may be any of a printing apparatus, a printer, a copier, a multi-functional peripheral, and a facsimile apparatus, for example.

### Image Forming Apparatus

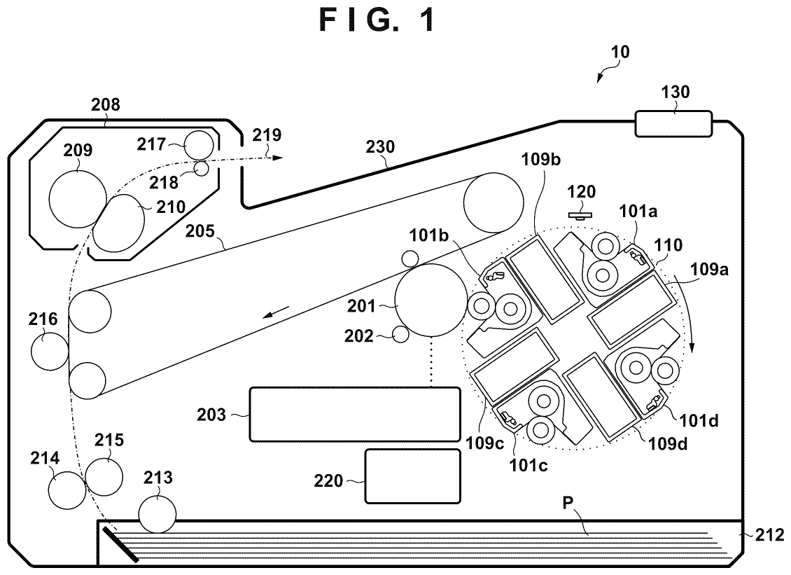

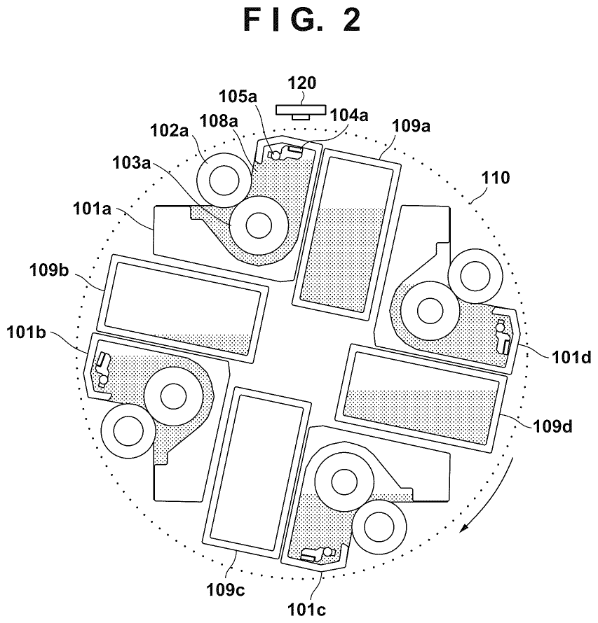

FIG. 1 is a cross-sectional diagram showing an exemplary configuration of an image forming apparatus 10, which is an image forming apparatus according to an embodiment of the present disclosure. FIG. 2 is a cross-sectional diagram showing an exemplary configuration related to a rotary 110, a plurality of development devices 101a, 101b, 101c, and 101d supported by the rotary 110, and a magnetic sensor 120, which are included in the image forming apparatus 10.

The image forming apparatus 10 includes a photosensitive drum 201, which is an image bearing member (photosensitive member) with a photosensitive layer formed on a surface thereof, a charging roller (charging unit) 202, and a laser scanner (exposure unit) 203. The charging roller 202 charges the surface of the photosensitive drum 201. Thereafter, the laser scanner 303 forms electrostatic latent images on the photosensitive drum 201 by irradiating the photosensitive drum 201 with laser light based on image data.

The image forming apparatus 10 further includes a rotatable rotary 110, a plurality of development devices 101a, 101b, 101c, and 101d supported by the rotary 110, and an intermediate transfer member 205. The plurality of development devices 101a, 101b, 101c, and 101d are configured to develop the electrostatic latent images on the photosensitive drum 201 with use of developers (toner) of different colors (yellow (Y), magenta (M), cyan (C), and black (K)). Along with rotation of the rotary 110, the plurality of development devices 101a, 101b, 101c, and 101d move to a position opposing the photosensitive drum 201 (a development position) in order. Among the plurality of development devices 101a, 101b, 101c, and 101d, a development device 101 that has moved to the development position forms a toner image on the photosensitive drum 201 by developing an electrostatic latent image on the photosensitive drum 201 with use of toner of a corresponding color.

The image forming apparatus 10 includes the rotary 110 that supports the development device (accommodation unit) 101a. The development devices 101b, 101c, and 101d that are similarly supported by the rotary 110 are configured similarly to the development device 101a. Toner containers 109a, 109b, 109c, and 109d that respectively contain developers (toner) used in development by the development devices 101a, 101b, 101c, and 101d are attached to the rotary 110. The toner containers 109a, 109b, 109c, and 109d are attachable to and removable from a body of the image forming apparatus 10.

Once the toner container 109a has been attached to the image forming apparatus 10 (rotary 110), the toner container 109a and the development device 101a on the developing side are placed in a state where they are in communication with each other, and toner is supplied from the toner container 109a to the inside of the development device 101a. When toner inside the development device 101a has decreased, the corresponding toner container 109a replenishes the development device 101a with toner as appropriate. The development device 101a accommodates toner in the aforementioned manner. The development device 101b and the toner container 109b, the development device 101c and the toner container 109c, and the development device 101d and the toner container 109d are also similar to the development device 101a and the toner container 109a. In the image forming apparatus 10 of the present embodiment, each development device 101 (101a, 101b, 101c, and 101d) is an example of an accommodation unit that accommodates toner.

As shown in FIG. 2, the development device 101a includes a development roller 102a and a supply roller 103a. The supply roller 103a supplies toner inside the development device 101a to the development roller 102a. The development roller 102a develops an electrostatic latent image formed on the photosensitive drum 201 by supplying toner to the photosensitive drum 201. That is to say, the development roller 102a develops an electrostatic latent image formed on the photosensitive drum 201 with use of toner accommodated inside the development device 101a. As a result, a toner image of toner of the color corresponding to the development device 101a is formed on the photosensitive drum 201. After forming the toner image that uses toner accommodated in the development device 101a, toner images that use toner accommodated in the development devices 101b, 101c, and 101d are similarly formed in order. In the image forming apparatus 10 of the present embodiment, (I) the development device 101a (accommodation unit), (II) the development roller 102a, and (III) a later-described permanent magnet 104a compose a development unit that develops an electrostatic latent image on the photosensitive drum 201 with use of toner of a corresponding color.

The toner images of the respective colors, which are formed on the photosensitive drum 201 in order by the development devices 101a, 101b, 101c, and 101d, are formed on the intermediate transfer member 205 in such a manner that they overlap one another. As a result, a multi-color toner image is formed on the intermediate transfer member 205. The multi-color toner image formed on the intermediate transfer member 205 is conveyed to a transfer nip portion between a transfer roller 216 and the intermediate transfer member 205 along with rotation of the intermediate transfer member 205. In harmony with the timing at which the toner image arrives at the transfer nip portion, a recording material P is conveyed from a paper feeding unit 212 to the transfer nip portion via a conveyance path 219. The recording material P contained in the paper feeding unit 212 is fed to the conveyance path 219 via a paper feeding roller 213, and then conveyed on the conveyance path 219 via such conveyance rollers as conveyance rollers 214 and 215. At the transfer nip portion, the transfer roller 216 transfers the toner image on the intermediate transfer member 205 to the recording material P that has been conveyed via the conveyance path 219. The recording material P to which the toner image has been transferred is conveyed to a fixing apparatus 208.

The fixing apparatus 208 includes a pressurizing roller 209 and a heating roller 210. The recording material P is conveyed in a state where it is held between the pressurizing roller 209 and the heating roller 210; as a result, the pressure and heat applied by the pressurizing roller 209 and the heating roller 210 cause the toner image to be fixed on the recording material P. Thereafter, the recording material P is discharged to a discharge tray 230 by conveyance rollers 217 and 218.

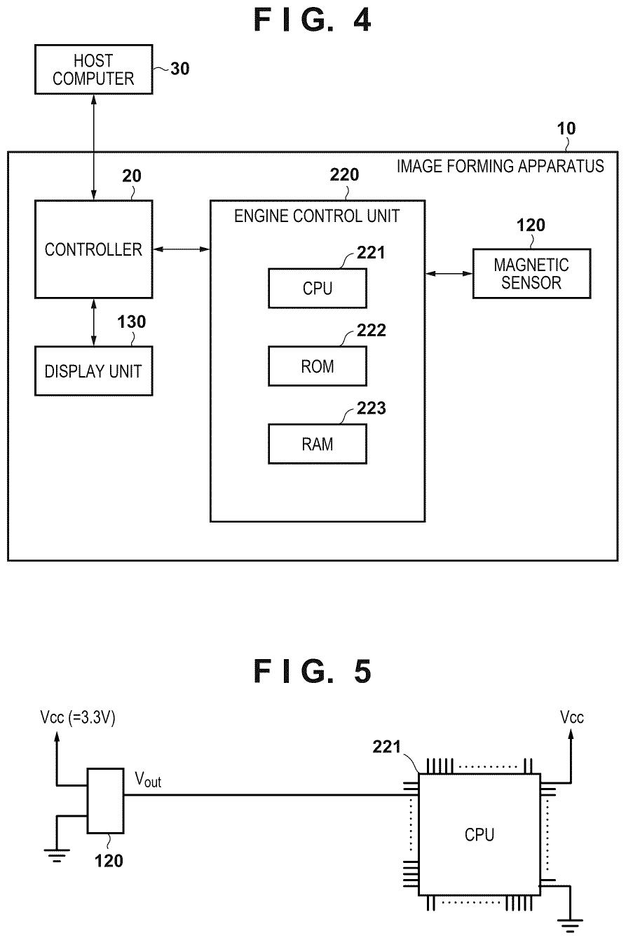

The image forming apparatus 10 includes an engine control unit 220 (hereinafter also referred to as a “control unit 220”) that controls the entirety of the image forming apparatus 10. A description is now given of an exemplary control configuration of the image forming apparatus 10 with use of FIG. 4. The image forming apparatus 10 includes a controller 20, a display unit 130, and an engine control unit 220. A host computer 30 transmits a print job to the image forming apparatus 10. In a case where the controller 20 has received a print job from the host computer 30, it causes the engine control unit 220 to control an image forming operation that is based on this print job. The display unit 130 is a display apparatus capable of displaying information. The display unit 130 is a display apparatus that includes, for example, a display screen, such as a display. Also, the engine control unit 220 includes at least one CPU 221 (processor), a ROM 222, and a RAM 223. The ROM 222 is a nonvolatile memory that holds (stores) control programs and various types of data. For example, the ROM 222 stores a determination result about a toner amount determined by the CPU 221. The RAM 223 is a volatile memory that stores temporary data. The CPU 221 can execute various types of control in the image forming apparatus 10 by executing control programs stored in one or more memories, such as the ROM 222 and the RAM 223.

The CPU 221 is configured to determine the amounts of toner that are respectively contained in the plurality of development devices 101a, 101b, 101c, and 101d (remaining toner amounts) based on an output signal of the magnetic sensor 120. Based on the determination results about the remaining toner amounts, the CPU 221 can inform a user of the determined remaining toner amounts by displaying them on the display unit 130 of the image forming apparatus 10, or by transmitting them to an external apparatus, such as a PC. Also, based on the determination result about the remaining toner amounts, the CPU 221 can inform the user of the necessity to exchange the toner containers 109a, 109b, 109c, and 109d, and prompt the exchange of these toner containers.

### Determination About Toner Amount Inside Development Device

Although the following description will be provided using the development device 101a as an example in relation to determination about a toner amount inside a development device, the following description similarly applies to the development device 101b, the development device 101c, and the development device 101d as well. Therefore, a description of the development device 101b, the development device 101c, and the development device 101d is omitted.

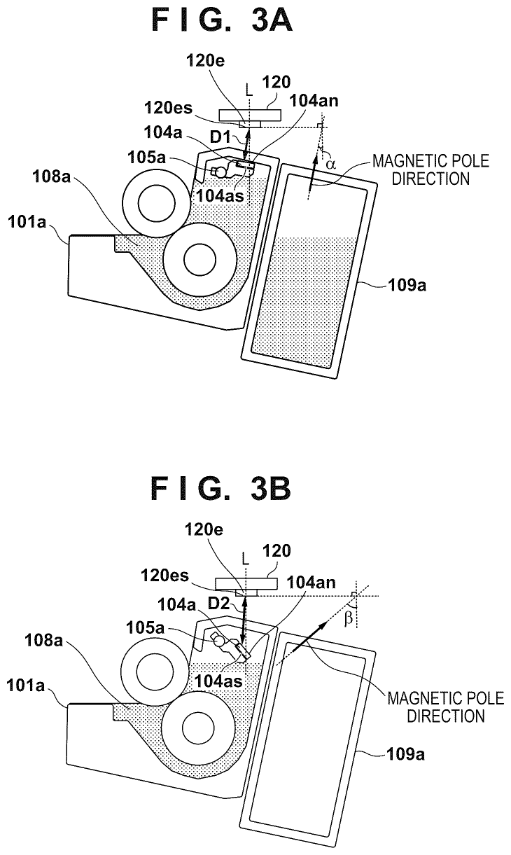

FIG. 3A and FIG. 3B are cross-sectional diagrams showing an exemplary configuration for determining (detecting) the amount of toner inside the development device 101a. Note, it can also be said that FIG. 3A and FIG. 3B are diagrams as viewed along the direction of a rotation shaft of the rotary 110. Note, the rotational orientation (rotational phase) of the rotary 110 is the same in FIG. 3A and FIG. 3B.

The development device 101a includes a movable holder 105a (support member), which holds a magnet (permanent magnet) 104a at one side thereof, and which is mounted inside the development device 101a via a movable rotation shaft at the other side thereof. The movable holder 105a is held in such a manner that it can rotate relative to the accommodation unit (development device 101a) inside the accommodation unit. The movable holder 105a holds the permanent magnet 104a. That is to say, the movable holder 105a and the permanent magnet 104a can rotate in an integrated manner relative to the accommodation unit.

The movable holder 105a is movable in such a manner that at least a part of the permanent magnet 104a is located above a toner surface of toner 108a in the vertical direction during rotation of the rotary 110. As such, the permanent magnet 104a is an example of a permanent magnet which is held inside the accommodation unit (development device 101a), and which changes in position relative to the accommodation unit in accordance with a toner amount inside the accommodation unit. The permanent magnet 104a can be formed of, for example, a neodymium magnet of a predetermined mechanical dimension (e.g., 4 mm×4 mm×1 mm in the vertical, horizontal, and thickness directions, respectively).

As shown in FIG. 3A, in a case where the toner amount inside the development device 101a is large, when the rotary 110 has rotated, the permanent magnet 104a is placed in a state where the longitudinal direction thereof and the magnetic sensor 120 form a plane-to-plane angle so that they are almost parallel to each other, and a distance therefrom to the magnetic sensor 120 is relatively close. The permanent magnet 104a passes in front of the magnetic sensor 120 in this state.

Here, the rotational orientation of the rotary 110 in FIG. 3A and FIG. 3B is referred to as a “first rotational orientation”. Also, an imaginary line that passes through the magnetic sensor 120 and extends in the vertical direction is referred to as an “imaginary line L”. The first rotational orientation is an orientation where the permanent magnet 104a is located on the imaginary line L when viewed along the direction of the rotation shaft of the rotary 110. Also, the remaining toner amounts inside the development device 101 in FIG. 3A and FIG. 3B are respectively referred to as a “first amount” and a “second amount”. The second amount is smaller than the first amount. A state of the rotary 110 when the toner amount inside the development device 101 is the first amount and the rotary 110 is in the first rotational orientation is referred to as a “first state”. A state of the rotary 110 when the toner amount inside the development device 101 is the second amount and the rotary 110 is in the first rotational orientation is referred to as a “second state”.

Note that in the following description, the position of the permanent magnet 104a when the permanent magnet 104a is located closest to the magnetic sensor 120 is referred to as a “proximity position”. The proximity position is a position where the shortest distance between the permanent magnet 104a and the magnetic sensor 120 becomes the smallest among the positions that can be taken by the permanent magnet 104a. The permanent magnet 104a shown in FIG. 3A and FIG. 3B is at the proximity position. That is to say, both of the first state and the second state are a state of the rotary 110 when the permanent magnet 104a is at the proximity position.

As shown in FIG. 3A, it is assumed that the shortest distance between the magnetic sensor 120 and the permanent magnet 104a when the rotary 110 is in the first state is D1. Also, as shown in FIG. 3B, it is assumed that the shortest distance between the magnetic sensor 120 and the permanent magnet 104a when the rotary 110 is in the second state is D2. D2 is longer than D1 (D1<D2). That is to say, the shortest distance between the magnetic sensor 120 and the permanent magnet 104 is longer when the rotary 110 is in the second state than when the rotary 110 is in the first state.

As shown in FIG. 3B, in a case where the toner amount inside the development device 101a is small, the movable holder 105a becomes tilted so as to become distant from the magnetic sensor 120; as a result, the permanent magnet 104a is placed in a state where the longitudinal direction thereof and the magnetic sensor 120 form an almost vertical plane-to-plane angle, and the distance between the permanent magnet 104a and the magnetic sensor 120 is relatively long. The permanent magnet 104a passes in front of the magnetic sensor 120 in this state.

The permanent magnet 104a includes a magnetic pole surface 104as with an S polarity, and a magnetic pole surface 104an with an N polarity. That is to say, it can be said that the permanent magnet 104a includes a first magnetic pole surface and a second magnetic pole surface that has a polarity opposite to that of the first magnetic pole surface. The magnetic flux (magnetic field lines) formed by the permanent magnet 104 proceeds from the magnetic pole surface 104as to the magnetic pole surface 104an. Here, the direction proceeding from one magnetic pole surface (the first magnetic pole surface) to the other magnetic pole surface (the second magnetic pole surface) between the magnetic pole surface 104as and the magnetic pole surface 104an is referred to as a “magnetic pole direction”.

Also, the magnetic sensor 120 includes a magnetic flux detection element 120e. The magnetic flux detection element 120e includes a detection surface 120es for detecting a magnetic flux based on the magnetic flux (magnetic field lines) penetrating therethrough. That is to say, the more the magnetic flux (magnetic field lines) penetrating through the detection surface 120es, the larger the signal output from the magnetic flux detection element 120e.

As shown in FIG. 3A, it is assumed that an angle formed by the magnetic pole direction and the normal direction of the detection surface 120es when the rotary 110 is in the first state is an angle α (a first angle). Also, as shown in FIG. 3B, it is assumed that an angle formed by the magnetic pole direction and the normal direction of the detection surface 120es when the rotary 110 is in the second state is β (a second angle). The angle β is larger than the angle α (α<β). That is to say, the angle formed by the magnetic pole direction and the normal direction of the detection surface 120es increases as the rotary 110 makes a transition from the first state to the second state. As a result, it becomes difficult for the magnetic sensor 120 to detect a magnetic field of the permanent magnet 104. That is to say, it can also be said that the magnetic flux penetrating through the detection surface 120es decreases.

In the image forming apparatus 10 of the present embodiment, the permanent magnet 104a and the magnetic sensor 120 are relatively arranged so that the plane-to-plane angle at the time of passing in front of the magnetic sensor 120 changes in relation to the range of the toner amount inside the development device 101a, namely approximately 60% to 100%. One or both of the distance and the plane-to-plane angle between the permanent magnet 104a and the magnetic sensor 120 change in accordance with the toner amount inside the accommodation unit (inside the development device 101a).

As described above, in the present embodiment, the rotary 110 is an example of a rotary that is configured to support the development unit, which includes the development device 101a (accommodation unit), the development roller 102a, and the permanent magnet 104a, and to be capable of rotating. The permanent magnet 104a is an example of a permanent magnet which is held inside the accommodation unit (development device 101a), and which changes in position relative to the accommodation unit in accordance with the toner amount inside the accommodation unit. Also, the magnetic sensor 120 is an example of a magnetic sensor which is arranged outside the rotary 110, and which outputs signals by detecting a magnetic field formed by the permanent magnet 104a. The magnetic sensor 120 is composed of a bipolar detection sensor capable of detecting both of the S pole and the N pole of the permanent magnet.

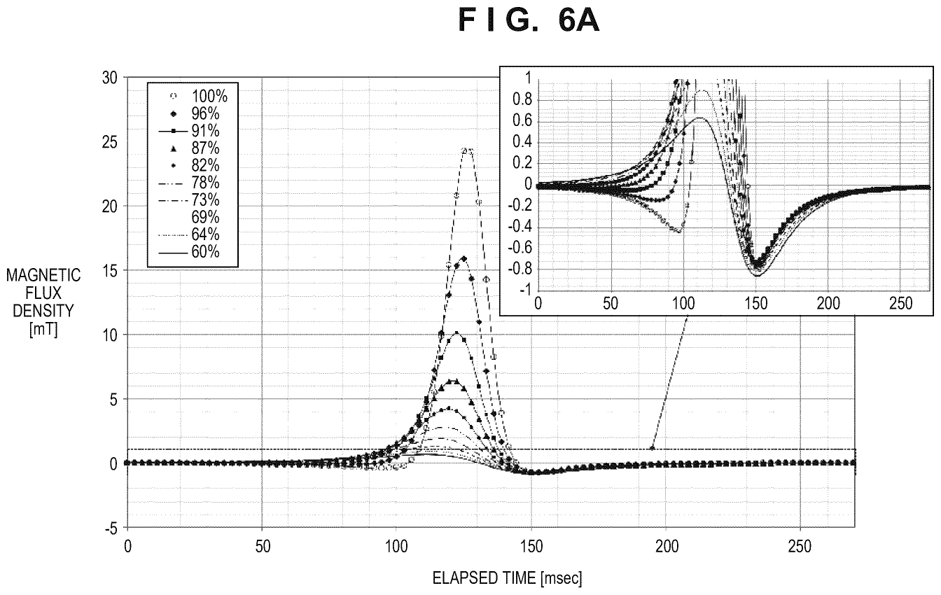

FIG. 5 shows an example of electrical connection between the CPU 221 inside the control unit 220 and the magnetic sensor 120. The control unit 220 is configured to determine the toner amount inside the development device 101a based on a result of detection by the magnetic sensor 120 (a result of detection of the magnetic field formed by the permanent magnet 104a). Both of the CPU 221 and the magnetic sensor 120 are driven by a power source voltage V_{cc}, which is a predetermined voltage (e.g., 3.3 V) generated by a power source (not shown). An output signal (output voltage) Vₒᵤₜ of the magnetic sensor 120 is supplied to the CPU 221 via a signal line.

As an example, the magnetic sensor 120 is composed of a linear-output Hall effect IC sensor. The magnetic sensor 120 considers a magnetic flux toward the S pole to be positive, and has a magnetic sensitivity of ±60 mV/mT. In a case where the magnetic flux penetrating through the magnetic sensor 120 in the vertical direction is 0 [mT], the magnetic sensor 120 outputs a voltage Vₒᵤₜ=V_{cc}/2. That is to say, in a case where the magnetic flux penetrating through the magnetic sensor 120 is 0 [mT], the output voltage Vₒᵤₜ converges on 1650 [mV].

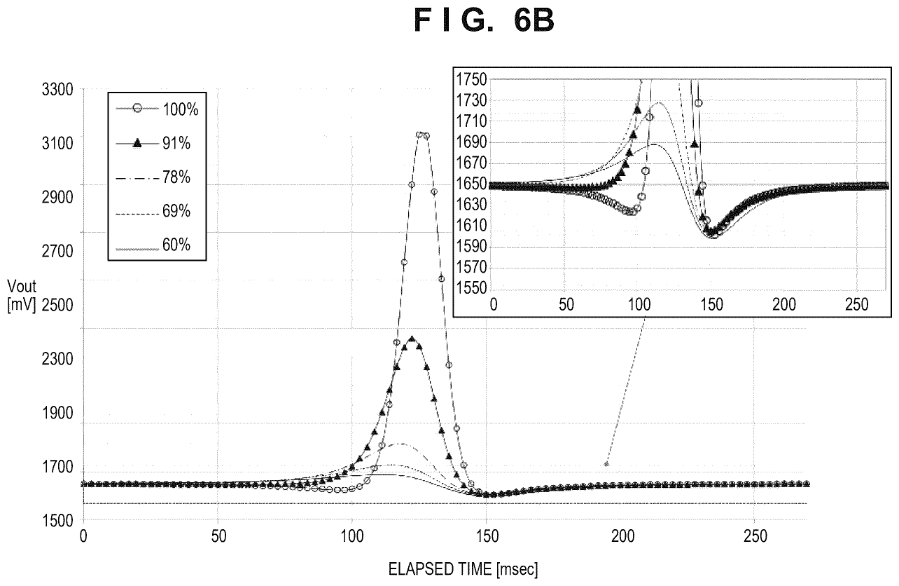

FIG. 6A shows an example of a change in the magnetic flux density of the magnetic flux penetrating through the magnetic sensor 120, which occurs along with rotation of the rotary 110. Note that a time section shown in FIG. 6A is a section at a time when the permanent magnet 104a passes in the vicinity of the magnetic sensor 120, and a vertical axis indicates a change in the magnetic flux density of the magnetic flux formed by the permanent magnet 104. Note that waveforms of FIG. 6A respectively correspond to cases of different remaining toner amounts in an accommodation unit.

As shown in an enlarged view of FIG. 6A, the direction of the magnetic flux penetrating through the magnetic sensor 120 is inverted when the development device 101a passes in the vicinity of the magnetic sensor 120 along with rotation of the rotary 110. Note that in the present embodiment, it is assumed that the direction from top to bottom in FIG. 3A and FIG. 3B is the positive direction of the magnetic flux relative to the magnetic sensor 120. Also, it is assumed that the direction from bottom to top in FIG. 3A and FIG. 3B is the negative direction of the magnetic flux relative to the magnetic sensor 120.

The magnetic sensor 120 outputs a voltage corresponding to a change in the magnetic flux density of the magnetic flux penetrating through the magnetic sensor 120, which is shown in FIG. 6A, to the CPU 221 as the voltage Vₒᵤₜ. FIG. 6B shows examples of a change in the output signal (output voltage) Vₒᵤₜ of the magnetic sensor 120 corresponding to a change in the magnetic flux density shown in FIG. 6A. As shown in FIG. 6A and FIG. 6B, the less the magnetic flux penetrating through the magnetic sensor 120 (the smaller the magnetic flux density thereof), the smaller the voltage Vₒᵤₜ output by the magnetic sensor 120. Meanwhile, the more the magnetic flux penetrating through the magnetic sensor 120 (the larger the magnetic flux density thereof), the larger the voltage Vₒᵤₜ output by the magnetic sensor 120. Therefore, the output voltage Vₒᵤₜ of the magnetic sensor 120 changes in accordance with the amount of toner contained in the development device 101a.

### Control Procedure

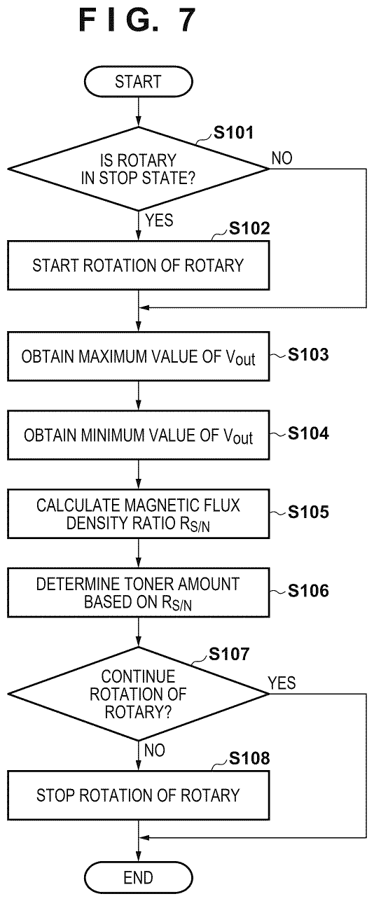

FIG. 7 is a flowchart showing an example of a procedure of determination control for determining a toner amount inside the development device 101a according to the present embodiment. The present procedure will be described in relation to an example of processing for determining the toner amount inside the development device 101a (inside the accommodation unit) based on a signal that is output by the magnetic sensor 120 through detection of the S pole of the permanent magnet 104a (a first signal), and on a signal that is output by the magnetic sensor 120 through detection of the N pole of the permanent magnet 104a (a second signal). In the present example, the control unit 220 determines the toner amount inside the development device 101a based on a result of detection by the magnetic sensor 120 that is obtained in a rotation period in which the rotary 110 has rotated in the range of one rotation or less. Note that the determination control for the toner amounts inside the development devices 101b, 101c, and 101d can be performed in a similar manner.

Once the control unit 220 (CPU 221) has started the determination control for the toner amount, it checks the state of the rotary 110 and determines whether the rotary 110 is in a rotating state in which it is rotating in step S101. In a case where the rotary 110 is not in the rotating state, the control unit 220 causes processing to proceed from step S101 to step S102, and causes the rotary 110 to start rotating. Thereafter, the control unit 220 causes processing to proceed to step S103. On the other hand, in a case where the rotary 110 is in the rotating state, the control unit 220 causes processing to proceed from step S101 to step S103. For example, the rotary 110 can be in a state where it is already rotating in a case where an image forming operation is currently executed, or the determination control for the toner amounts inside other development devices 101b, 101c, and 101d is currently executed, before starting the determination control for the toner amount inside the development device 101a.

In steps S103 to S105, the control unit 220 executes processing for determining the toner amount based on a ratio between the maximum value of the magnetic flux density of the magnetic flux penetrating through the magnetic sensor 120 in the positive direction and the maximum value of the magnetic flux density of the magnetic flux penetrating through the magnetic sensor 120 in the negative direction (a magnetic flux density ratio) while the rotary 110 is rotating.

In steps S103 and S104, the control unit 220 obtains and saves (the absolute values of) the maximum value (instantaneous value) V_{Smax} and the minimum value V_{Nmax} of the output signal (output voltage) Vₒᵤₜ of the magnetic sensor 120 when the development device 101a passes in the vicinity of the magnetic sensor 120 while the rotary 110 is rotating. Here, the control unit 220 uses, as a reference value, the output signal value (the value of the output voltage Vₒᵤₜ) of the magnetic sensor 120 of a case where the magnetic flux penetrating through the magnetic sensor 120 is 0 [mT]. In this case, the output voltage Vₒᵤₜ is Vₒᵤₜ=V_{cc}/2 as stated earlier. Therefore, when Vₒᵤₜ>V_{cc}/2, the magnetic flux penetrates through the magnetic sensor 120 in the positive direction (a first direction). Meanwhile, when Vₒᵤₜ<V_{cc}/2, the magnetic flux penetrates through the magnetic sensor 120 in the negative direction (a second direction that is opposite to the first direction).

Here, in the present example, the output signal of the magnetic sensor 120 of a case where the magnetic flux is penetrating through the magnetic sensor 120 in the positive direction (a signal corresponding to Vₒᵤₜ>V_{cc}/2) is an example of the signal that is output by the magnetic sensor 120 through detection of the S pole of the permanent magnet 104a (the first signal). The output signal of the magnetic sensor 120 of a case where the magnetic flux is penetrating through the magnetic sensor 120 in the negative direction (a signal corresponding to Vₒᵤₜ<V_{cc}/2) is an example of the signal that is output by the magnetic sensor 120 through detection of the N pole of the permanent magnet 104a (the second signal). Also, the minimum value V_{Nmax} of the output voltage Vₒᵤₜ is an example of the maximum output value that is output by the magnetic sensor 120 through detection of the N pole in the rotation period of the rotary 110 (a first output value). The maximum value V_{Smax} of the output voltage Vₒᵤₜ is an example of the maximum output value that is output by the magnetic sensor 120 through detection of the S pole in the rotation period of the rotary 110 (a second output value).

In a case where the magnetic flux is penetrating through the magnetic sensor 120 in the positive direction, an absolute value of an amount of change in the maximum value V_{Smax} of the output voltage Vₒᵤₜ relative to the output voltage Vₒᵤₜ of a case where the magnetic flux penetrating through the magnetic sensor 120 is 0 [mT] (the reference value) is as follows.

The amount of change in the positive direction=V_{Smax}−V_{cc}/2 (1)

Meanwhile, in a case where the magnetic flux is penetrating through the magnetic sensor 120 in the negative direction, an absolute value of an amount of change in the minimum value V_{Nmax} of the output voltage Vₒᵤₜ relative to the output voltage Vₒᵤₜ of a case where the magnetic flux penetrating through the magnetic sensor 120 is 0 [mT] (the reference value) is as follows.

The amount of change in the negative direction=V_{cc}/2−V_{Nmax} (2)

In this way, the control unit 220 obtains the absolute value of the difference between the maximum value of the output signal of the magnetic sensor 120 while the rotary 110 is rotating and the reference value as the maximum value of the magnetic flux density in the positive direction (step S103). Also, the control unit 220 obtains the absolute value of the difference between the minimum value of the output signal of the magnetic sensor 120 while the rotary 110 is rotating and the reference value as the maximum value of the magnetic flux density in the negative direction (step S104).

Thereafter, the control unit 220 executes processing for determining the toner amount in the development device 101a by calculating a value indicating a relationship between the first output value (minimum value V_{Nmax}) and the second output value (maximum value V_{Smax}) with use of the first output value and second output value. In the present example, the control unit 220 obtains a magnetic flux density ratio R_{S/N} as a value indicating the relationship between the first output value (minimum value V_{Nmax}) and the second output value (maximum value V_{Smax}). Note that the determination about the toner amount may be made based on, for example, a ratio between the first output value and the second output value.

Next, in step S105, the control unit 220 obtains the ratio (magnetic flux density ratio) R_{S/N} between the maximum value of the magnetic flux density of a case where the magnetic flux is penetrating through the magnetic sensor 120 in the positive direction and the maximum value of the magnetic flux density of a case where the magnetic flux is penetrating through the magnetic sensor 120 in the negative direction. The magnetic flux density ratio R_{S/N} is obtained based on formulae (1) and (2) with use of the following formula.

R_{S/N}=(V_{Smax}−V_{cc}/2)/(V_{cc}/2−V_{Nmax}) tm (3)

In the present example, the magnetic flux density ratio R_{S/N} is an example of a ratio between the absolute value of the difference between the first output value and the reference value and the absolute value of the difference between the second output value and the reference value.

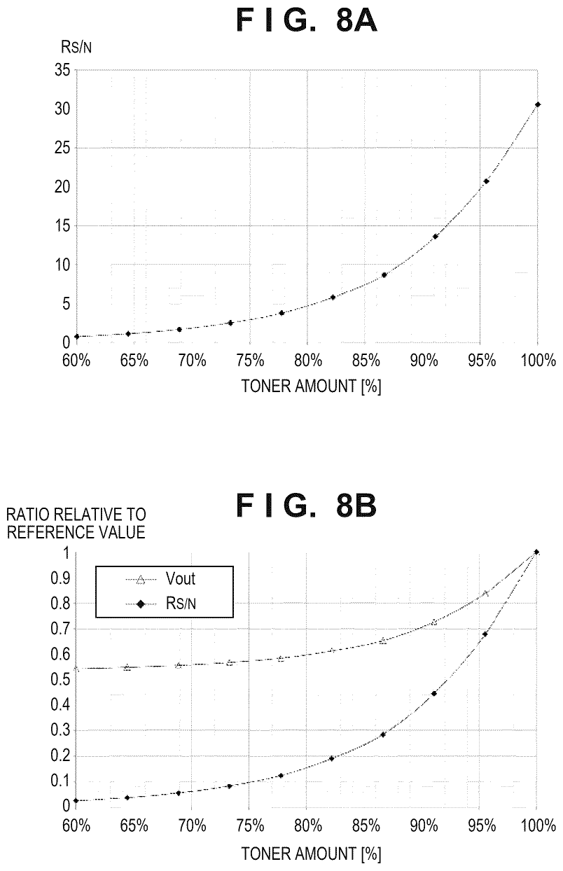

In step S106, the control unit 220 determines the toner amount inside the development device 101a based on the magnetic flux density ratio R_{S/N} obtained in step S105. FIG. 8A shows an example of a relationship between the toner amount inside the development device 101a and the magnetic flux density ratio R_{S/N}. As shown in FIG. 8A, the relationship is as follows: the smaller the toner amount inside the development device 101a, the smaller the magnetic flux density ratio R_{S/N}; the larger the toner amount inside the development device 101a, the larger the magnetic flux density ratio R_{S/N}. The image forming apparatus 10 of the present embodiment saves a table indicating such a relationship between the magnetic flux density ratio R_{S/N} and the toner amount inside the development device 101a in advance in the ROM 222 inside the control unit 220. Therefore, the control unit 220 determines the toner amount by obtaining a toner amount Tₙ corresponding to the magnetic flux density ratio R_{S/N} obtained in step S105 with reference to the saved table. The determined toner amount Tₙ can be saved inside the control unit 220.

Note that in the present example, a range of 60% to 100% is set as a range for determining the toner amount inside the development device 101a (a determination range) as shown in FIG. 8A; however, no limitation is intended by this. Also, the determination about the toner amount may be made using a method other than the above-described method of using the table saved inside the control unit 220; for example, the determination may be made using a relational formula indicating the relationship between the magnetic flux density ratio R_{S/N} and the toner amount inside the development device 101a.

Thereafter, in step S107, the control unit 220 determines whether to continue the rotation of the rotary 110. For example, it is determined that the rotation of the rotary 110 is to be continued in a case where the image forming operation is to be executed subsequently, or in a case where the determination control for the toner amounts inside other development devices 101b, 101c, and 101d is to be further performed. In a case where the rotation of the rotary 110 is to be continued, the control unit 220 maintains the rotary 110 in the rotating state, and ends processing of the present procedure. On the other hand, in a case where the rotation of the rotary 110 is not to be continued, the control unit 220 causes processing to proceed to step S108. In step S108, the control unit 220 stops a rotation operation of the rotary 110 so that the rotary 110 stops at a predetermined position, and ends processing of the present procedure.

FIG. 8B shows an example of the relationship among the toner amount inside the development device 101a, the maximum value of the output signal (output voltage) Vₒᵤₜ of the magnetic sensor 120, and the magnetic flux density ratio R_{S/N}. In the present example, a value corresponding to a toner amount of 100% inside the development device 101a is used as a reference value with respect to the maximum value of the output voltage Vₒᵤₜ and the magnetic flux density ratio R_{S/N}, and a relative value corresponding to this reference value is indicated.

The maximum value of the output voltage Vₒᵤₜ is proportional to the magnetic flux (magnetic flux density) penetrating through the magnetic sensor 120 in the positive direction. As shown in FIG. 8B, regarding the output voltage Vₒᵤₜ, the maximum value of the output voltage Vₒᵤₜ corresponding to a toner amount of 60% is approximately 0.55 times the maximum value of the output voltage Vₒᵤₜ corresponding to a toner amount of 100% inside the development device 101a. On the other hand, regarding the magnetic flux density ratio R_{S/N}, the magnetic flux density ratio R_{S/N} corresponding to a toner amount of 60% is approximately 0.02 times the magnetic flux density ratio R_{S/N} corresponding to a toner amount of 100% inside the development device 101a. In this way, it is apparent that the breadth of change (dynamic range) in the magnetic flux density ratio R_{S/N} is larger than that in the maximum value of the output voltage Vₒᵤₜ relative to the change in the toner amount inside the development device 101a.

Therefore, in the determination about the toner amount inside the development device 101a, the toner amount can be determined more accurately when the magnetic flux density ratio R_{S/N} is used than when the maximum value of the output voltage Vₒᵤₜ of the magnetic sensor 120 is used. Compared to a case where the toner amount inside the development device 101a is determined using only the absolute value of the magnetic flux density (the absolute value of the output voltage Vₒᵤₜ), in a case where the magnetic flux density ratio R_{S/N} is used, an influence of variations in magnetization of the permanent magnet 104a and the like can be reduced. That is to say, with the determination control for the toner amount according to the present embodiment, the determination accuracy can be increased compared to a case where the toner amount inside the development device 101a is determined using only the maximum value of the output voltage Vₒᵤₜ of the magnetic sensor 120 (the maximum value of the magnetic flux density of the magnetic flux penetrating through the magnetic sensor 120 in the positive direction). In this way, by determining the toner amount inside the development device 101a based on the signal that is output by the magnetic sensor 120 through detection of the S pole of the permanent magnet 104a (the first signal) and the signal that is output by the magnetic sensor 120 through detection of the N pole of the permanent magnet 104a (the second signal), the determination accuracy can be increased compared to a case where only the first signal is used.

As described above, the image forming apparatus 10 of the present embodiment includes a magnetic sensor 120 which is arranged outside the rotary 110, and which outputs signals by detecting a magnetic field (magnetic flux) formed by the permanent magnet 104a held inside the development device 101a (accommodation unit). The image forming apparatus 10 further includes the control unit 220 that determines a toner amount inside the development device 101a based on signals output from the magnetic sensor 120. The control unit 220 is configured to determine a toner amount inside the development device 101a based on a signal that is output by the magnetic sensor 120 through detection of the S pole of the permanent magnet 104a (the first signal), and on a signal that is output by the magnetic sensor 120 through detection of the N pole of the permanent magnet 104a (the second signal). According to the present embodiment, the determination accuracy can be further increased by determining a toner amount inside the development device 101a with use of not only the first signal, but also the second signal, as the signals of the magnetic sensor 120. In this way, a novel image forming apparatus that determines a remaining amount of toner inside the development device 101a can be provided.

### Second Embodiment

In the second embodiment, in a rotation period in which the rotary 110 has rotated in the range of one rotation or less, the control unit 220 obtains an integral value (a first integral value) related to the first signal (the signal that is output by the magnetic sensor 120 through detection of the S pole of the permanent magnet 104a) in a period in which the magnetic flux penetrates through the magnetic sensor 120 in the positive direction (a first period). Also, in the rotation period in which the rotary 110 has rotated in the range of one rotation or less, the control unit 220 obtains an integral value (a second integral value) related to the second signal (the signal that is output by the magnetic sensor 120 through detection of the N pole of the permanent magnet 104a) in a period in which the magnetic flux penetrates through the magnetic sensor 120 in the negative direction (a second period). Thereafter, the control unit 220 determines a toner amount inside the development device 101a based on a ratio between the first integral value and the second integral value (an integral value ratio). The following mainly describes portions that are different from the first embodiment.

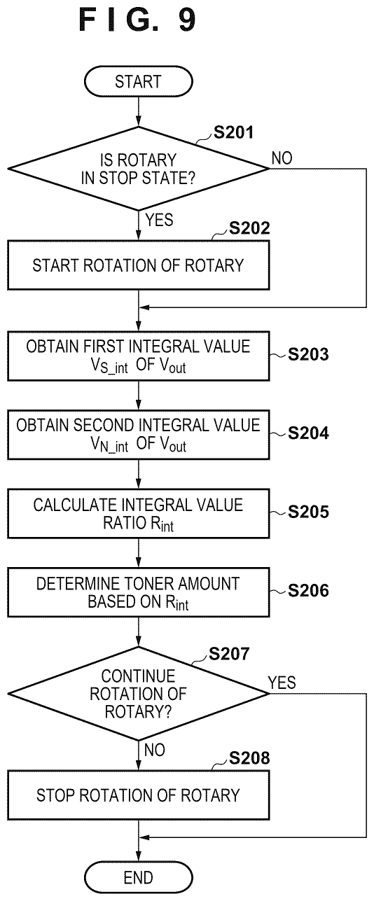

FIG. 9 is a flowchart showing an example of a procedure of determination control for determining a toner amount inside the development device 101a according to the present embodiment. Note that the determination control for the toner amounts inside the development devices 101b, 101c, and 101d can be performed in a similar manner.

Steps S201 and S202 are similar to steps S101 and S102 of the first embodiment. When processing has proceeded from step S201 or S202 to step S203, the control unit 220 obtains and saves a first integral value V_{S_int} of the output signal (output voltage) Vₒᵤₜ of the magnetic sensor 120 when the development device 101a passes in the vicinity of the magnetic sensor 120 in step S203. The first integral value V_{S_int} is obtained as an integral value of the output voltage Vₒᵤₜ of the magnetic sensor 120 in a period (first period) from when the output voltage Vₒᵤₜ has exceeded a first threshold V_{ST1} until when the output voltage Vₒᵤₜ falls below a second threshold V_{ST2}. The aforementioned first period is specified as a period in which the magnetic flux generated by the permanent magnet 104a penetrates through the magnetic sensor 120 in the positive direction. In the present example, the first integral value V_{S_int} is obtained as a cumulative value of the values of the output voltage Vₒᵤₜ of the magnetic sensor 120 obtained at a predetermined time interval (e.g., at an interval of 2.8 milliseconds) in the aforementioned first period. The first integral value V_{S_int} is equivalent to an integral value related to the magnetic flux density of the magnetic flux that is generated by the permanent magnet 104a and penetrates through the magnetic sensor 120 in the positive direction. Note that the aforementioned predetermined time interval is not limited to 2.8 milliseconds. The aforementioned first integral value V_{S_int} is an example of the first integral value related to the first signal (the signal that is output by the magnetic sensor 120 through detection of the S pole of the permanent magnet 104a) obtained in the first period within the rotation period in which the rotary 110 has rotated in the range of one rotation or less.

Furthermore, in step S204, the control unit 220 obtains and saves the second integral value V_{N_int} of the output signal (output voltage) Vₒᵤₜ of the magnetic sensor 120 when the development device 101a passes in the vicinity of the magnetic sensor 120. The second integral value V_{N_int} is obtained as an integral value of the output voltage Vₒᵤₜ of the magnetic sensor 120 in a period from when the output voltage Vₒᵤₜ has fallen below a third threshold V_{ST3} until when the output voltage Vₒᵤₜ exceeds a fourth threshold V_{ST4} (the second period). The aforementioned second period is specified as a period in which the magnetic flux generated by the permanent magnet 104a penetrates through the magnetic sensor 120 in the negative direction. In the present example, the second integral value V_{N_int} is obtained as a cumulative value of the values of the output voltage Vₒᵤₜ of the magnetic sensor 120 obtained at a predetermined time interval (e.g., at an interval of 2.8 milliseconds) in the aforementioned second period. The second integral value V_{N_int} is equivalent to an integral value related to the magnetic flux density of the magnetic flux that is generated by the permanent magnet 104a and penetrates through the magnetic sensor 120 in the negative direction. The aforementioned second integral value V_{N_int} is an example of a second integral value related to the second signal (the signal that is output by the magnetic sensor 120 through detection of the N pole of the permanent magnet 104a) obtained in the second period within the rotation period in which the rotary 110 has rotated in the range of one rotation or less.

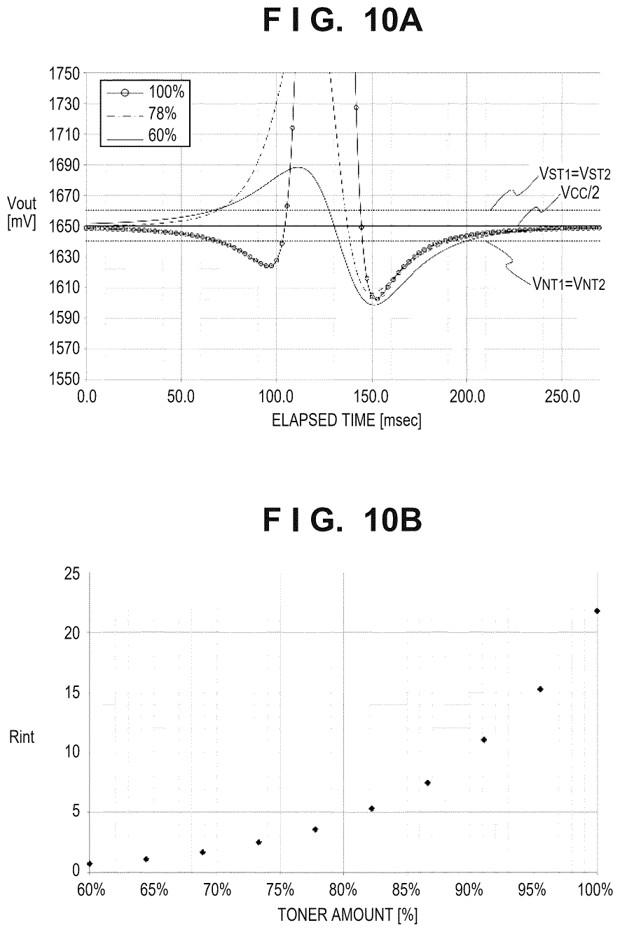

FIG. 10A shows examples of changes in the output signal (output voltage) Vₒᵤₜ of the magnetic sensor 120 of cases where the toner amount inside the development device 101a is 60%, 78%, and 100%. In FIG. 10A, as an example, the first threshold V_{ST1} and the second threshold V_{ST2} are set as follows: V_{ST1}=V_{ST2}=V_{cc}/2+10 [mV]. Furthermore, the following is set: V_{ST3}=V_{ST4}=V_{cc}/2−10 [mV]. In this case, a cumulative value of the output voltage Vₒᵤₜ in a period in which Vₒᵤₜ exceeds the threshold V_{ST1}=V_{ST2} is obtained as the first integral value V_{S_int}. Furthermore, a cumulative value of the output voltage Vₒᵤₜ in a period in which Vₒᵤₜ falls below the threshold V_{ST3}=V_{ST4} is obtained as the second integral value V_{N_int}.

Next, in step S205, the control unit 220 obtains the ratio (integral value ratio) Rᵢ between the first integral value VS_int related to the magnetic flux density of a case where the magnetic flux is penetrating through the magnetic sensor 120 in the positive direction and the second integral value V_{N_int} related to the magnetic flux density of a case where the magnetic flux is penetrating through the magnetic sensor 120 in the negative direction. That is to say, Rᵢₙₜ is obtained using the following formula.

Rᵢₙₜ=V_{S_int}/V_{N_int} (4)

In step S206, the control unit 220 determines a toner amount inside the development device 101a based on the integral value ratio Rᵢₙₜ obtained in step S205. Here, FIG. 10B shows an example of a relationship between the toner amount inside the development device 101a and the integral value ratio Rᵢₙₜ. As shown in FIG. 10B, the relationship is as follows: the smaller the toner amount inside the development device 101a, the smaller the integral value ratio Rᵢₙₜ; the larger the toner amount inside the development device 101a, the larger the integral value ratio Rᵢₙₜ. The image forming apparatus 10 of the present embodiment saves a table indicating such a relationship between the integral value ratio Rᵢₙₜ and the toner amount inside the development device 101a in advance inside the control unit 220 (e.g., the ROM therein). Therefore, the control unit 220 determines the toner amount by obtaining a toner amount Tₙ corresponding to the integral value ratio Rᵢₙₜ obtained in step S205 with reference to the saved table. The determined toner amount Tₙ can be saved inside the control unit 220.

Note that in the present example, a range of 60% to 100% is set as a range for determining the toner amount inside the development device 101a (a determination range) as shown in FIG. 10B; however, no limitation is intended by this. Also, the determination about the toner amount may be made using a method other than the above-described method of using the table saved inside the control unit 220; for example, the determination may be made using a relational formula indicating the relationship between the integral value ratio Rᵢₙₜ and the toner amount inside the development device 101a.

Thereafter, in step S207, the control unit 220 determines whether to continue the rotation of the rotary 110, similarly to step S107. In a case where the rotation of the rotary 110 is to be continued, the control unit 220 maintains the rotary 110 in the rotating state, and ends processing of the present procedure. In a case where the rotation of the rotary 110 is not to be continued, processing proceeds to step S208. In step S208, the control unit 220 stops a rotation operation of the rotary 110 so that the rotary 110 stops at a predetermined position, and ends processing of the present procedure.

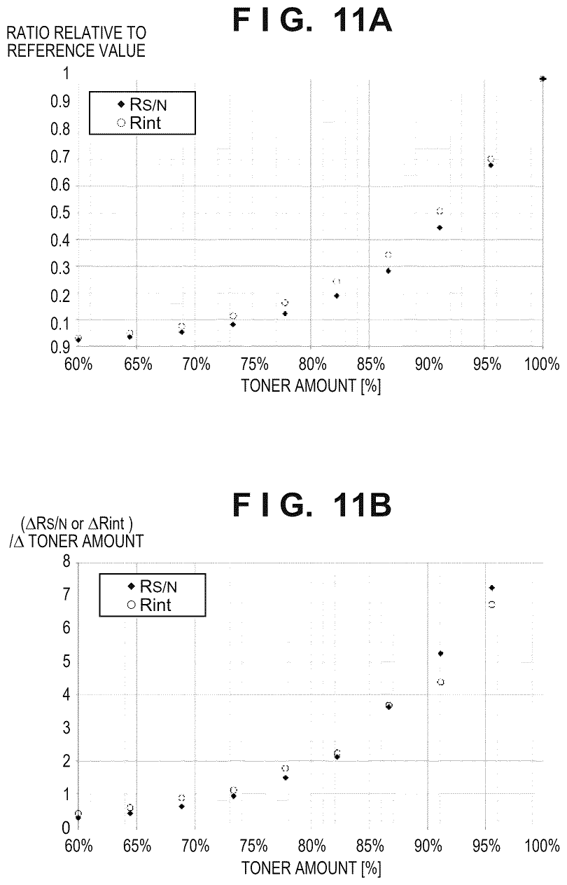

FIG. 11A shows an example of the relationship among the toner amount inside the development device 101a, the magnetic flux density ratio R_{S/N}, and the integral value ratio Rᵢₙₜ between the magnetic flux densities. In the present example, a value corresponding to a toner amount of 100% inside the development device 101a is used as a reference value with respect to the magnetic flux density ratio R_{S/N} and the integral value ratio Rᵢₙₜ, and a relative value corresponding to this reference value is indicated.

As shown in FIG. 11A, regarding the magnetic flux density ratio R_{S/N}, the magnetic flux density ratio R_{S/N} corresponding to a toner amount of 60% is approximately 0.02 times the magnetic flux density ratio R_{S/N} corresponding to a toner amount of 100% inside the development device 101a. Meanwhile, regarding the integral value ratio Rᵢₙₜ, the integral value ratio Rᵢₙₜ corresponding to a toner amount of 60% is approximately 0.03 times the integral value ratio Rᵢₙₜ corresponding to a toner amount of 100% inside the development device 101a. In this way, the breadth of change (dynamic range) in the integral value ratio Rᵢₙₜ is slightly smaller than, but is substantially equal to, that in the magnetic flux density ratio R_{S/N} relative to the change in the toner amount inside the development device 101a.

On the other hand, FIG. 11B shows an example of a relationship between a change in the toner amount inside the development device 101a, and a change in the magnetic flux density ratio R_{S/N} or the integral value ratio Rᵢₙₜ between the magnetic flux densities relative to a change in the toner amount inside the development device 101a (Δ toner amount). As shown in FIG. 11B, it is apparent that the sensitivity of the change in the integral value ratio Rᵢₙₜ relative to the change in the toner amount (Δ toner amount) is high in a region in which the toner amount inside the development device 101a is equal to or smaller than 85%. Also, the determination about the toner amount that uses the integral value ratio Rᵢₙₜ is less likely to be influenced by, for example, variations in magnetization of the permanent magnet 104a and the like, similarly to the determination about the toner amount that uses the magnetic flux density ratio R_{S/N}. Therefore, for example, in the region in which the toner amount inside the development device 101a is equal to or smaller than 85% (a region in which the toner amount is equal to or smaller than a predetermined amount), the determination can be made in a timelier manner when the toner amount inside the development device 101a is determined using the integral value ratio Rᵢₙₜ than when the toner amount is determined based on the magnetic flux density ratio R_{S/N}. Therefore, the control unit 220 may use the determination about the toner amount that is based on the magnetic flux density ratio R_{S/N} and the determination about the toner amount that is based on the integral value ratio Rᵢₙₜ separately depending on the toner amount inside the development device 101a. For example, the control unit 220 may be configured to determine the toner amount with use of the integral value ratio Rᵢₙₜ in a case where the toner amount inside the development device 101a is equal to or smaller than the predetermined amount (e.g., 85%), and with use of the magnetic flux density ratio R_{S/N} in other cases.

As described above, in the image forming apparatus 10 of the present embodiment, the control unit 220 obtains, in a rotation period in which the rotary 110 has rotated in the range of one rotation or less: a first integral value related to a first signal (a signal that is output by the magnetic sensor 120 through detection of the S pole of the permanent magnet 104a) in a first period in which the magnetic flux penetrates through the magnetic sensor 120 in the positive direction; and a second integral value related to a second signal (a signal that is output by the magnetic sensor 120 through detection of the N pole of the permanent magnet 104a) in a second period in which the magnetic flux penetrates through the magnetic sensor 120 in the negative direction. The control unit 220 determines a toner amount inside the development device 101a based on a ratio between the first integral value and the second integral value (an integral value ratio Rᵢₙₜ). In this way, the toner amount inside the development device 101a can be determined with higher accuracy, similarly to the first embodiment, and at the same time, the determination can be made with higher sensitivity relative to a change in the toner amount.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-033159, filed Mar. 3, 2025, which is hereby incorporated by reference herein in its entirety.

What is claimed is:

1. An image forming apparatus, comprising:
a development unit including
(I) an accommodation unit configured to accommodate toner and which includes a permanent magnet therein, the permanent magnet being changeable in position relative to the accommodation unit in accordance with a toner amount inside the accommodation unit, and
(II) a development roller that develops an electrostatic latent image formed on a photosensitive member with use of the toner accommodated in the accommodation unit;
a rotary that supports the development unit and which is rotatable;
a magnetic sensor arranged outside the rotary to detect a magnetic field formed by the permanent magnet and to output a signal based on the detection; and
a control unit that determines the toner amount inside the accommodation unit based on the output signal,
wherein the magnetic sensor is a bipolar detection sensor that detects both an S pole and an N pole of the permanent magnet, and
when the output signal output by the magnetic sensor upon detecting the S pole of the permanent magnet is a first signal, and when the output signal output by the magnetic sensor upon detecting the N pole of the permanent magnet is a second signal, the control unit determines the toner amount in the accommodation unit based on the first signal and the second signal.

2. The image forming apparatus according to claim 1, wherein
provided that
a proximity position is a position at which the permanent magnet is closest to the magnetic sensor,
a first orientation is an orientation of the rotary in a case where the permanent magnet is at the proximity position,
a first state is a state of the rotary in a case where the rotary is in the first orientation and the toner amount in the accommodation unit is a first amount, and
a second state is a state of the rotary in a case where the rotary is in the first orientation and the toner amount in the accommodation unit is a second amount that is smaller than the first amount,
a shortest distance between the permanent magnet and the magnetic sensor in the second state is longer than a shortest distance between the permanent magnet and the magnetic sensor in the first state.

3. The image forming apparatus according to claim 2, wherein
the magnetic sensor is provided above the rotary.

4. The image forming apparatus according to claim 2, wherein
the magnetic sensor includes a detection surface through which magnetic field lines of the permanent magnet penetrate,
the permanent magnet includes a first magnetic pole surface and a second magnetic pole surface that has a polarity opposite to a polarity of the first magnetic pole surface, and
provided that
a magnetic pole direction is a direction from the first magnetic pole surface to the second magnetic pole surface,
a first angle is an angle formed by the magnetic pole direction and a normal direction of the detection surface in the first state, and
a second angle is an angle formed by the magnetic pole direction and the normal direction in the second state,
the second angle is larger than the first angle.

5. The image forming apparatus according to claim 1, wherein
the control unit determines the toner amount in the accommodation unit based on the first signal and the second signal in a rotation period in which the rotary has rotated in a range of one rotation or less.

6. The image forming apparatus according to claim 5, wherein
provided that
a first output value is a maximum output value that is output by the magnetic sensor through detection of the S pole in the rotation period, and
a second output value is a maximum output value that is output by the magnetic sensor through detection of the N pole in the rotation period,
the control unit determines the toner amount in the accommodation unit based on the first output value and the second output value.

7. The image forming apparatus according to claim 6, wherein
the control unit determines the toner amount in the accommodation unit by calculating a value indicating a relationship between the first output value and the second output value with use of the first output value and the second output value.

8. The image forming apparatus according to claim 7, wherein
the control unit determines the toner amount in the accommodation unit based on a ratio between the first output value and the second output value.

9. The image forming apparatus according to claim 6, wherein
provided that a reference value is an output signal value of the magnetic sensor in a case where an amount of magnetic flux penetrating through the magnetic sensor is 0,
the control unit determines the toner amount in the accommodation unit based on a ratio between an absolute value of a difference between the first output value and the reference value, and an absolute value of a difference between the second output value and the reference value.

10. The image forming apparatus according to claim 1, wherein
the control unit determines the toner amount based on a ratio between a first integral value and a second integral value within a rotation period in which the rotary has rotated in a range of one rotation or less, the first integral value being an integral value related to the first signal in a first period, the second integral value being an integral value related to the second signal in a second period.

11. The image forming apparatus according to claim 10, wherein
the first period is a period from when a signal value of the first signal exceeds a first threshold to when the signal value of the first signal falls below a second threshold, and
the second period is a period from when a signal value of the second signal falls below a third threshold to when the signal value of the second signal exceeds a fourth threshold.

12. The image forming apparatus according to claim 11, wherein
the second threshold is equal to the first threshold, and the fourth threshold is equal to the third threshold.

13. The image forming apparatus according to claim 11, wherein
the first integral value is obtained as a cumulative value of signal values of the first signal obtained at a predetermined time interval in the first period, and
the second integral value is obtained as a cumulative value of signal values of the second signal obtained at the predetermined time interval in the second period.
